(19) United States
(12) Patent Application Publication
(10) Pub. No.: US 2016/0310339 A1
(43) Pub. Date: Oct. 27, 2016

(54) METHOD AND APPARATUS FOR SLIDING A BED-BOUND PERSON

(71) Applicant: Jonathan Lopez, Torrance, CA (US)

(72) Inventor: Jonathan Lopez, Torrance, CA (US)

(21) Appl. No.: 15/200,740

(22) Filed: Jul. 1, 2016

Related U.S. Application Data
(60) Provisional application No. 62/257,095, filed on Nov. 18, 2015.

(51) Int. Cl. A61G 7/10; A45F 3/14; A61G 7/05

(52) U.S. Cl. CPC A61G 7/1026; A61G 7/0504; A61G 7/1023; A61G 7/104; A45F 3/14; A45F 2003/146; A45F 2003/144

(57) ABSTRACT

Method and apparatus for sliding a bed-bound person by first attaching a force member to a stratum such as a bed sheet. A horizontal force is then applied to the force member and is increased until the stratum begins to slide. A substantially opposite horizontal force is conveyed upon a human body, substantially proximate to a lower back region.

### RELATED APPLICATIONS

The present application claims priority to U.S. Provisional Application Ser. No. 62/257,095, entitled “Polyester/cotton vest that incorporates a harness to enable health care workers to safely move patients without back injuries” by Lopez, and which was filed on Nov. 18, 2015.

### BACKGROUND

There has been a long standing and yet unrecognized problem in the health care profession. There are many situations where the position or location of a patient must be changed. Moving from one position to the next may be as simple as rolling a patient from a position such as laying on their back, to a position laying on their side. As harmless as this act may seem, even such a simple repositioning of a patient can lead to injury when a caregiver must apply a pulling force to a part of the patient. The injury we speak of here is not to the patient, but rather is an injury sustained by the caregiver, as shall be further explained below.

FIG. 1 is a pictorial diagram that depicts the forces a caregiver typically experiences when pulling a patient. Such forces are often encountered when moving a patient to a new location or repositioning a patient. Typically, the caregiver is in a standing position when the caregiver applies a force 6 to a patient. This force 6 is typically a horizontal force relative to the standing posture of the caregiver and is usually in-line with the caregiver's forearm. Of course, the forearm is typically bent upward at the elbow in order to apply the horizontal pulling force to a patient. And, even though this discussion assumes that the horizontal force is applied directly to a patient, it is equally, if not more applicable to a situation where a caregiver is applying a horizontal force to a stratum upon which a patient is either completely, or partially situated upon.

A simple static analysis of the forces involved here reveals that the horizontal force 6 that is applied to the patient, or a stratum, must be countered by a substantially equal, but opposite horizontal force 7. It is apparent that the opposing force 7 cannot be in-line with the first pulling force 6 because there is no mechanical member to carry the opposing force 7 to a fixed point. Here, the fixed point is higher than that of the hand that is pulling upon the patient, namely at the shoulder of the caregiver. As the caregiver applies the pulling force, the caregiver will experience torsional forces because the applied pulling force 6 and the opposing force 7 are not in-line with each other.

It should be appreciated that one such torsional force 11 is applied at a very weak region in the human body known as the rotator cuff 16. The opposing torsional force 12 is sustained by the lower back region of the torso in order to keep the caregiver upright. Otherwise, the first rotational force 11 will cause the caregiver to lean forward. Hence, the opposing force 12 is applied by the lower back muscles in order to keep the caregiver upright. It should be apparent that there are other forces applied by the floor upon the foot and lower leg of a human as a pulling force is applied by the arms. For example, the foot is prevented from moving horizontally by frictional forces created by the weight of the human as the human stands upon the floor. Also, we ignore the fact that there must be a torsional force situated about the ankle in order to keep the human upright.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial diagram that depicts the forces a caregiver typically experiences when pulling a patient;

FIG. 2 is a pictorial diagram that depicts one illustrative use case for one example of embodiment of an apparatus for sliding a bed-bound person;

FIG. 3 is a flow diagram that depicts one example method for sliding a bed-bound person which is disposed on a stratum;

FIG. 4 is a flow diagram that depicts several alternative methods for attaching a horizontal force member to a stratum;

FIG. 5 is a flow diagram that dictates one alternative method for attaching a horizontal force member to a stratum using a friction loop;

FIG. 6 is a flow diagram that depicts an alternative method for attaching a horizontal force member to a fabric handle;

FIG. 7 is a flow diagram that depicts an alternative method for applying horizontal force to a stratum in at least two places;

FIG. 8 is a flow diagram that depicts alternative example methods for attaching horizontal force member to a stratum;

FIG. 9 is a flow diagram that depicts alternative example methods where forces applied to the stratum are carried by the flanks of a human user;

FIG. 10 is a flow diagram that depicts a one alternative method where a force applied to a first flank and a force applied to a second flank are distributed around a posterior region of a lower-back portion of a human user;

FIG. 11 is a pictorial diagram that depicts one alternative example embodiment of a torsional stress reducing harness;

FIGS. 12 and 13 are pictorial diagrams of one alternative example embodiment of a slide loop;

FIGS. 14A and 14B are pictorial diagrams that depict the structure and operation of one alternative example embodiment of a constriction flap; and

FIGS. 15A and 15B are pictorial diagrams that depict an alternative embodiment of a retainer useful for attaching a tension band to a handle.

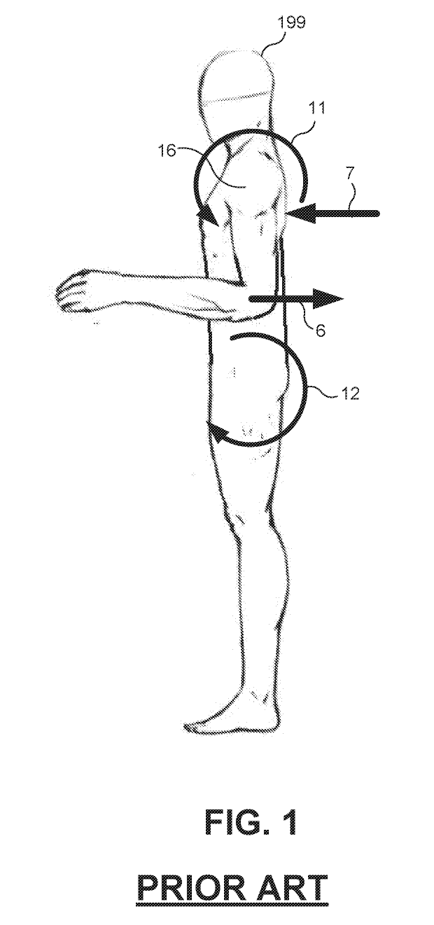

### DETAILED DESCRIPTION

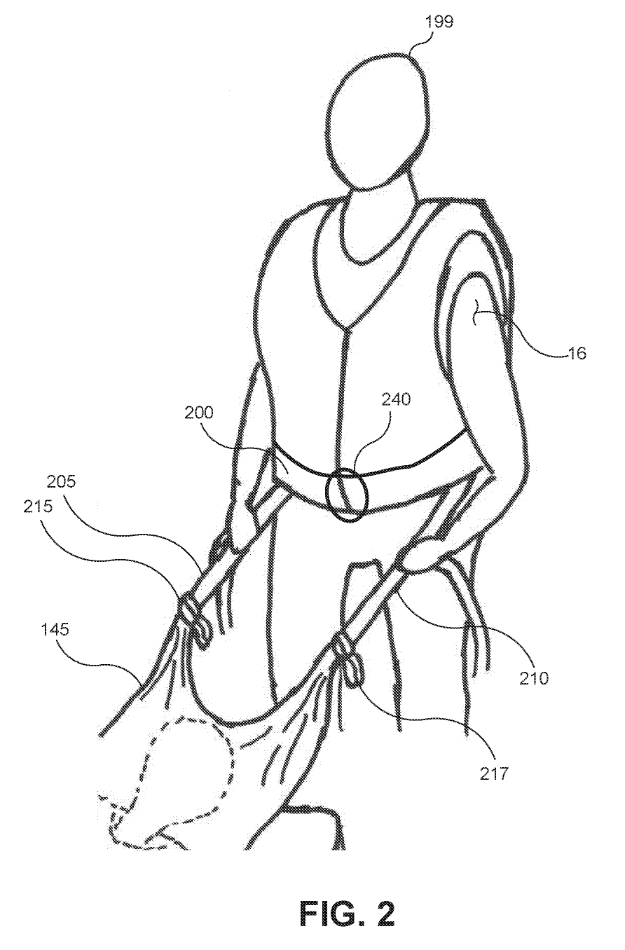

FIG. 2 is a pictorial diagram that depicts one illustrative use case for one example of embodiment of an apparatus for sliding a bed-bound person. The apparatus depict it in FIG. 2 comprises a torsional stress reducing harness 200. According to one example embodiment, the torsional stress reducing harness 200 comprises a first tension band 205. In yet another alternative example embodiment, the torsional stress reducing harness 200 further comprises a second tension band 210.

It should be appreciated that the placement of the tension bands (205, 210) varies based on a particular embodiment, which will become apparent in light of the discussion here. For example, in those embodiments that include only a single tension band 205, the single tension 205 band may be disposed centrally relative to a human user, which normally will wear the rotational stress reducing harness 200 around the waist. Likewise, in those embodiments that included two tension bands, for example the first tension band 205 and the second tension band 210 described above, those embodiments are structured to position one tension band on each flank of the rotational stress reducing harness 200, again relative to a human user.

This discussion is provided here in order to illustrate how a human user 199 may substantially eliminate all rotational and/or torsional forces upon either the lower back or the offset pivot-point of forces applied to a stratum, which is proximate to the interface of the upper arm to the torso of the human user 199. This point is typically at the rotator cuff (16).

It should be appreciated that, by utilizing the torsional stress reducing harness 200, the human user 199 experiences either no horizontal stresses, or substantially diminished stresses on either the forearm or the upper arm vis-à-vis the stresses ordinarily experienced by pulling, and/or tugging upon a stratum 145, which is illustrated in this figure as a bed sheet. It should further be appreciated that a bed sheet is only one example of a stratum upon which a human bed-bound person may be disposed upon. It is also important to recognize that not the entire body of such a bed-bound person need necessarily be entirely disposed upon the stratum. This shall become apparent through the teachings herein.

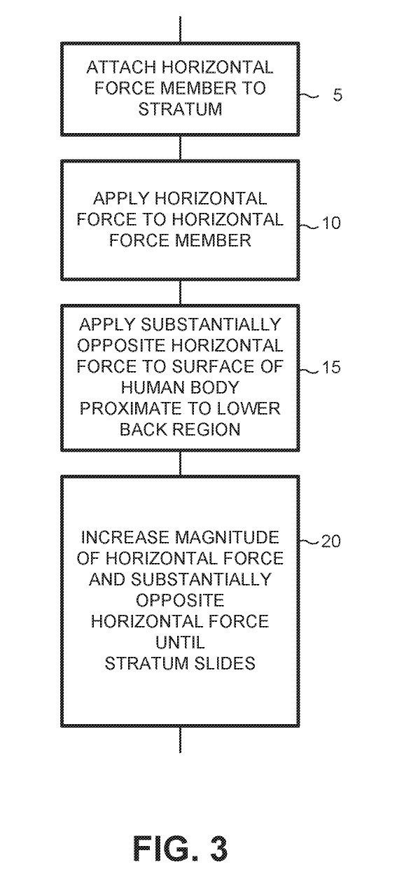

FIG. 3 is a flow diagram that depicts one example method for sliding a bed-bound person which is disposed on a stratum. It should be appreciated that any reference to a method step by a reference to a figure, e.g. “(step 1)”, is intended to include that method step in an open-ended enumeration of steps as provided in the method claims appended hereto. Again referring to FIG. 3, it should be apparent that a first step of the attaching a horizontal force member to a stratum (step 5) provides for a physical member which will carry force applied at one end of the horizontal force member and communicated to the stratum 145. Continuing with the present method, a horizontal force is then applied to the horizontal force member (step 10). It should likewise be appreciated that the force applied to the horizontal force member is oriented in a direction in which the bed-bound person situated on the stratum 145 is to be moved, or slid along a surface upon which the stratum 145 is disposed.

The force communicated to the stratum 145 requires an opposite force to be applied to a fixed point in order to cause a bed-bound person disposed on the stratum 145 to slide across a surface. As such a substantially opposite horizontal force is applied to the surface of the human body proximate to the lower back region step 15). It should likewise be appreciated that this force is itself opposed by other forces acting upon the human user 199. For example, the force applied to the lower back portion by the torsional stress reducing harness 200 is communicated to the floor upon which the human user 199 is standing. Although not specifically described herein, a human user 199 is likely to lean backward in order to impart a horizontal force upon the stratum. In this action, the human user typically maintains a foothold on the floor in such a “lean-back” action.

In order to overcome any friction between the stratum 145 and a surface upon which the stratum is situated, the horizontal force applied to the stratum 145 by way of the first horizontal force member 205 is increased until such a sliding action occurs (step 20). It should likewise be appreciated that such an increase in the magnitude of the horizontal force is communicated to the stratum 145 by way of the first horizontal force member 205 and the second horizontal force member 210 where the present method is embodied in a torsional stress reducing harness 200 that includes two such horizontal force members.

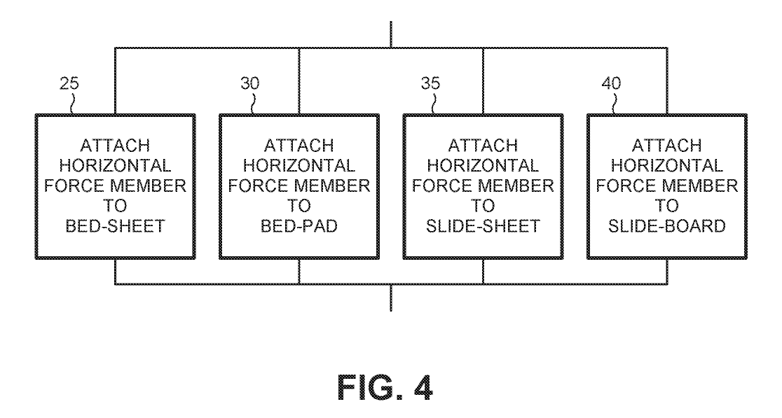

FIG. 4 is a flow diagram that depicts several alternative methods for attaching a horizontal force member to a stratum. It should be appreciated that a stratum is typically disposed upon a surface and a bed-bound person is then disposed upon the stratum. In such situation, the stratum is typically lining some portion of a surface, for example a bed or a gurney. In various health-care situations, the type of stratum is selected according to personal preference of a health-care provider, or according to medical requirements. As such, a caregiver may prefer using a bad-sheet as a stratum. Accordingly, one alternative example method provides for attaching a horizontal force member to such a bed-sheet (step 25). And in yet another alternative method, the horizontal force member is attached to a bed-pad (step 30). This is applicable in those situations where the caregiver has a preference for a bed-pad over some other form of strata.

According to yet another alternative example method, attaching a horizontal force member to a stratum comprises a attaching a horizontal force member to a slide-sheet (step 35). It should be appreciated that a slide-sheet is a specially fabricated stratum that serves to minimize fractional forces that may otherwise retard an intended sliding action as a human user 199 begins to increase the horizontal force applied to the stratum 145. One example where a medical requirement dictates the type of the stratum to be used to support a bed-bound person is depicted by a slide-board. A slide-board is a relatively rigid stratum which is used to maintain the posture of a bed-bound person. As such, one alternative method for attaching a force member to a stratum comprises attaching a horizontal force member to a slide-board (step 40).

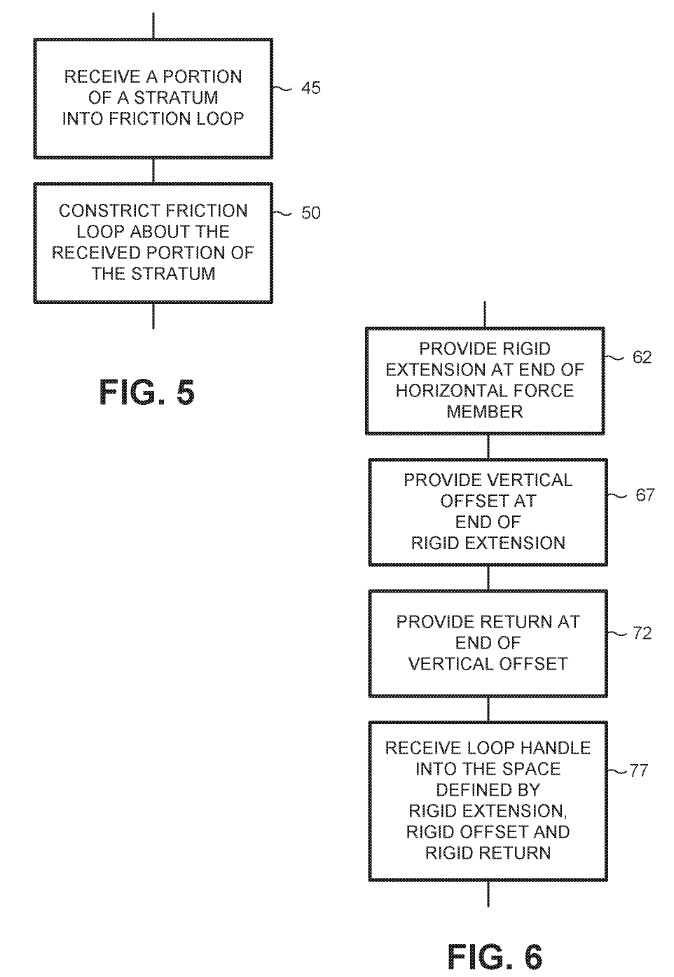

FIG. 5 is a flow diagram that dictates one alternative method for attaching a horizontal force member to a stratum using a friction loop. It should be appreciated that several various types of stratum are typically made a material that is relatively pliable, for example a cotton bed sheet. In such cases, a portion of the stratum is received into a friction loop (step 45). Once that portion of the stratum is received into the friction loop, the friction loop is then constricted about the received portion of the stratum (step 15). This technique is further illustrated infra as one alternative embodiment of a torsional stress reducing harness is descried.

FIG. 6 is a flow diagram that depicts an alternative method for attaching a horizontal force member to a fabric handle. In many situations, a stratum includes flexible handle that are sewn, or otherwise attached to the stratum. In such illustrative use cases, this method provides for providing a substantially rigid extension (step 62) to the end of a horizontal forced member where the attachment is to be made. Next, an offset (e.g. a vertical offset relative to the rigid extension) is them provided (step 67) at the end of the substantially rigid extension. A return is provided at the end of the offset (step 72). Once these members are provided, they define a region much akin to an open hook. The loop handle is then received into the hook region (step 77) that is defined by the rigid extension, the rigid offset and the rigid return. It should be appreciated that the members that define such a hook are typically substantially rigid.

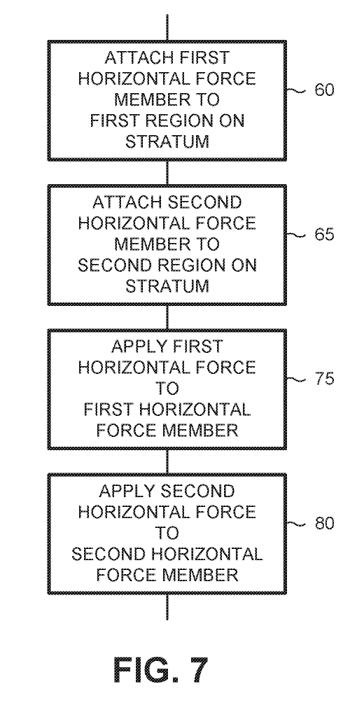

FIG. 7 is a flow diagram that depicts an alternative method for applying horizontal force to a stratum in at least two places. As already described, one alternative example embodiment of a torsional stress reducing harness 200 includes at least two horizontal force members. In such embodiments an alternative method is utilized for applying force to a stratum. In this alternative example method, a first horizontal force member is attached to a first region on the stratum (60). In one illustrative use case, which is not intended to limit the scope of the claims appended hereto, such a first region may include the first corner of a bed-sheet. Additionally, the second horizontal force member is attached to a second region on the stratum (step 65). In this same non-limiting illustrative use case, the second force member may be attached to a second corner of the bed sheet. According to this alternative example method, a first horizontal force is applied to the first horizontal member (step 75) and a second horizontal force is applied to the second horizontal force member (step 80) in order to effect a sliding action. Accordingly, the first and second horizontal forces need to be increased until such sliding occurs.

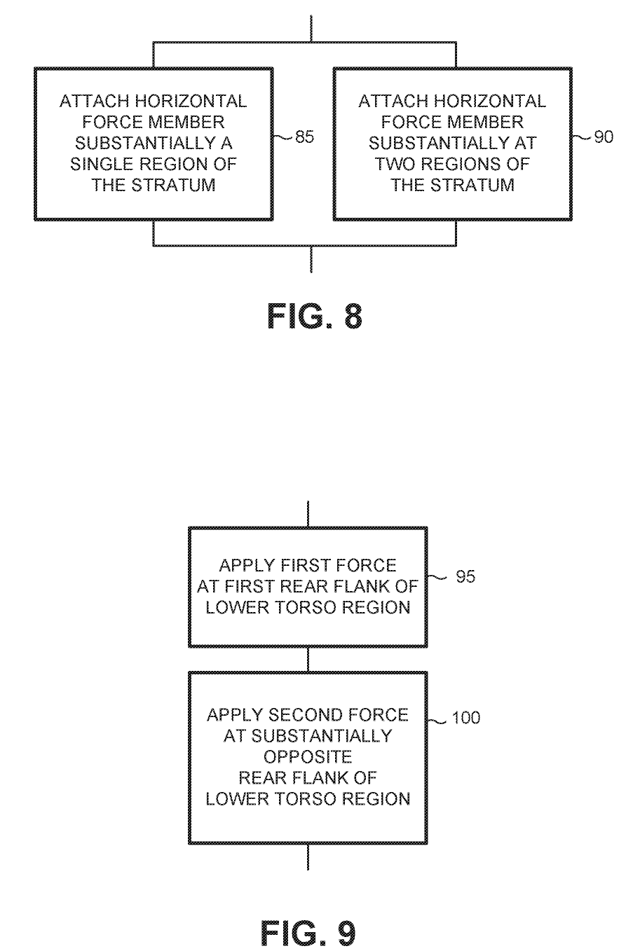

FIG. 8 is a flow diagram that depicts alternative example methods for attaching horizontal force member to a stratum. It should likewise be apparent that, according to various alternative example methods, a horizontal force is applied to the stratum using at least one of a single attached horizontal force member in a single region of the stratum (step 85) and attaching two horizontal force members substantially at two regions of the stratum (step 90).

FIG. 9 is a flow diagram that depicts alternative example methods where forces applied to the stratum are carried by the flanks of a human user. It should be appreciated that in those embodiments of a torsional stress reducing harness 200 that include at least two horizontal force members, the force applied upon a first horizontal force member is opposed by a substantially opposite opposing force applied at a first rear flank of a lower torso region of the human user 199 (step 95). Likewise, the force applied to the second horizontal force member is opposed by substantially opposite opposing force applied at a second rear flank of a lower torso region of the human user 199 (step 100). It should be appreciated that, according to this alternative example method, the forces applied to the first flank and the second flank are to be applied to flanks that are in substantial opposition to each other relative to the human body.

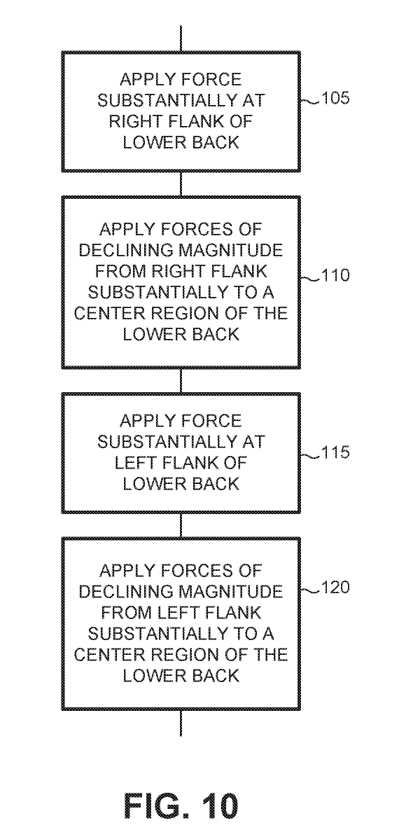

FIG. 10 is a flow diagram that depicts a one alternative method where a force applied to a first flank and a force applied to a second flank are distributed around a posterior region of a lower-back portion of a human user. It should be appreciated that a human user certainly could not absorb a single point force without sustaining severe injury. Accordingly, a force applied to a lower region of the back must be distributed over a greater surface area of the body. This is typically accomplished by a waistband that serves as attachment points for the horizontal force members that are attached to a stratum.

In this example method, a substantial portion of a first horizontal force is applied at a right flank of the lower back (step 105). The waistband then enables a distribution of the remainder of the force to be applied in declining magnitude from the right flank to a region proximate to the center of the lower back (step 110). In a substantially symmetric manner, a substantial portion of the second force is applied at the left flank of the lower back (step 115). The remainder of the second force is likewise distributed in declining magnitude from the left flank to a region proximate to the center of the lower back (step 120).

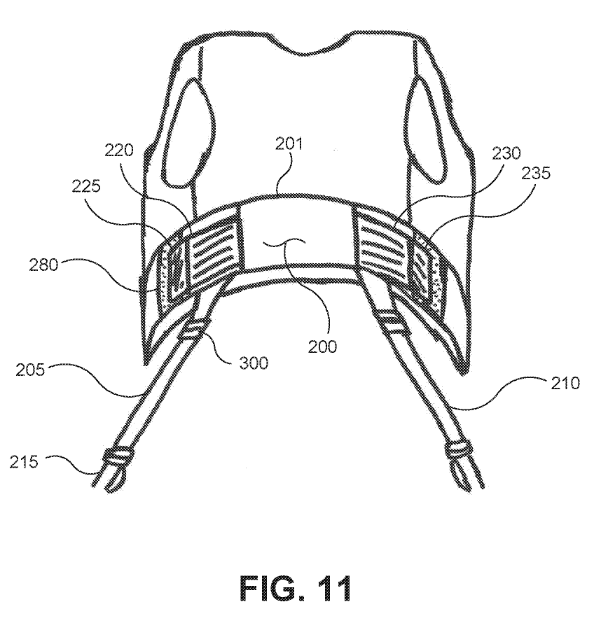

FIG. 11 is a pictorial diagram that depicts one alternative example embodiment of a torsional stress reducing harness. In this example embodiment, the torsional stress reducing harness comprise a waistband 201, a constriction flap 225 disposed on the outside of the waistband 201, a tension band 205, and a retainer 215 included in the end of the tension band 205. It should be appreciated that the tension band includes two ends. The first end of the tension band is secured to the waistband 201 and the second end is intended to be attached to a stratum in order to pull upon said stratum.

In this example embodiment, the constriction flap 220 is used to tighten the waistband 201 about the waist of a human user. In one alternative example embodiment, a first end of the constriction flap 220 is attached to the waistband 201. The second end of the constriction flap 220 includes an attachment device 225 that allows the second end of the constriction flap 220 to be attached to the waistband 201 at different positions. The waistband 201 of this alternative example embodiment includes a corresponding receiver structure 280, disposed on its outer surface that enables attachment of the second end of the constriction flap 220 at various positions along the waistband 201.

In one alternative example embodiment, the receiver structure 280 comprises at least one of a hook material and a loop material. It is not important if the receiver structure 280 includes hoop material or loop material so long as the corresponding material is included in the second end of a constriction flap 220.

FIG. 11 also depicts that a tension band includes a length adjustment device. Such length adjustment devices 300 are commonly found on back pack straps so that a back pack straps can be adjusted according to the comfort desires of a user of said back pack. Hence, the user here is able to adjust the distance from the harness 200 to the stratum 145. This is just one important feature because the safety of a patient may require less distance between the patient and the care-giver in some situations. In other situations, the care-giver may need additional distance from the patient in order to apply a leveraged force to the stratum in order to effect movement of the patient.

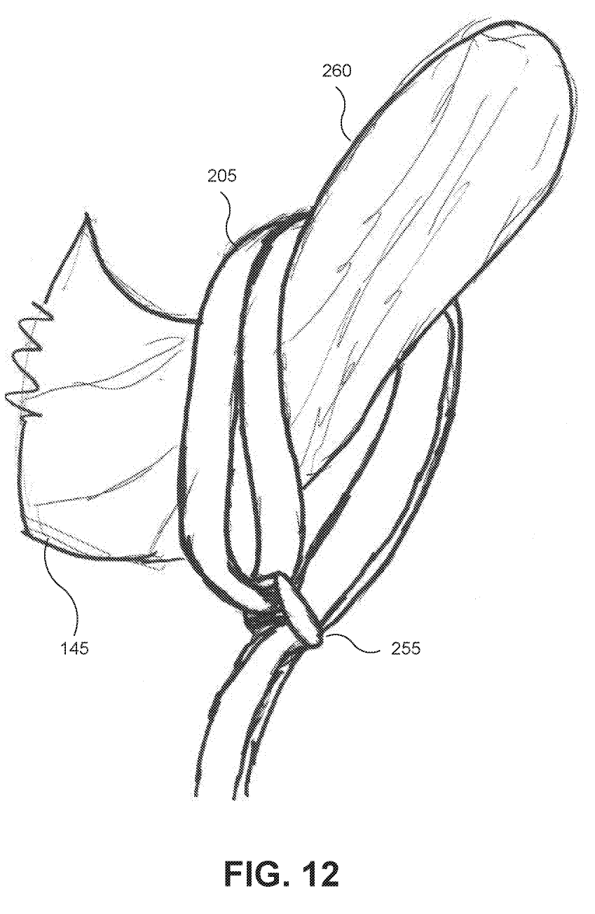

FIGS. 12 and 13 are pictorial diagrams of one alternative example embodiment of a slide loop, it should already be appreciated by the teachings of the present method that one embodiment of a retainer 285 included in the second end of the tension band 205 comprises a slip loop. In this example embodiment, the end of the tension band 205 is attached sliding device 255. The sliding device slides along the length of the tension band 205. When used by a human user, the end of the tension band 205 is moved back toward the waistband by moving the sliding device 255, thus forming a slip noose.

A portion 260 of the stratum 145 is pulled into the slip noose and then the slip noose is pulled closed (270 in FIG. 13) in order to grasp the portion 260 of the stratum 145. It should be appreciated that the sliding device 255 comprises two slots. One slot receives the torsion band 205 and is allowed to slide freely along the length of said torsion band. The second slot is used to retain the end of the torsion band 205. The end of the torsion band is typically fed through this second slot and is then folded over and attached to a point slightly back from the end of the torsion band 205.

In one alternative example embodiment, the constriction flap is 220 is secured to the waistband 201 proximate to a first flank region of a human user when the harness 200 is used by said human user. This alternative example embodiment includes a second constriction flap 230 that is secured proximate to a second flank region of a human user when the harness 200 is being used by said human user. In this alternative example embodiment, two corresponding receiver structures 225 and 235 are included in the waistband and disposed on its outer surface. These two receiver structures enable the first and second constriction flaps 220, 230 to attach to the waistband 201 at varying positions so that the waistband 201 may be tightened about the waist of human users with varying waist dimensions.

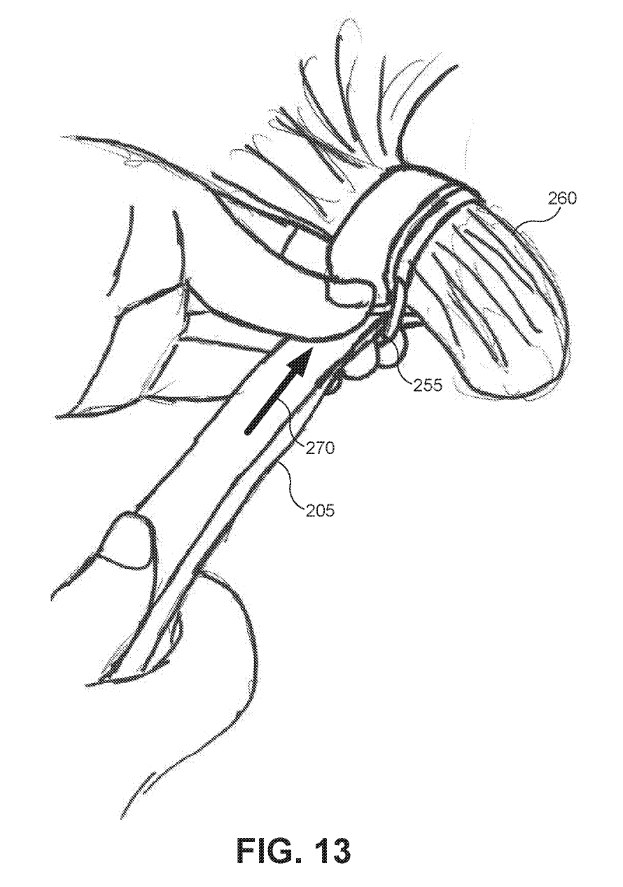

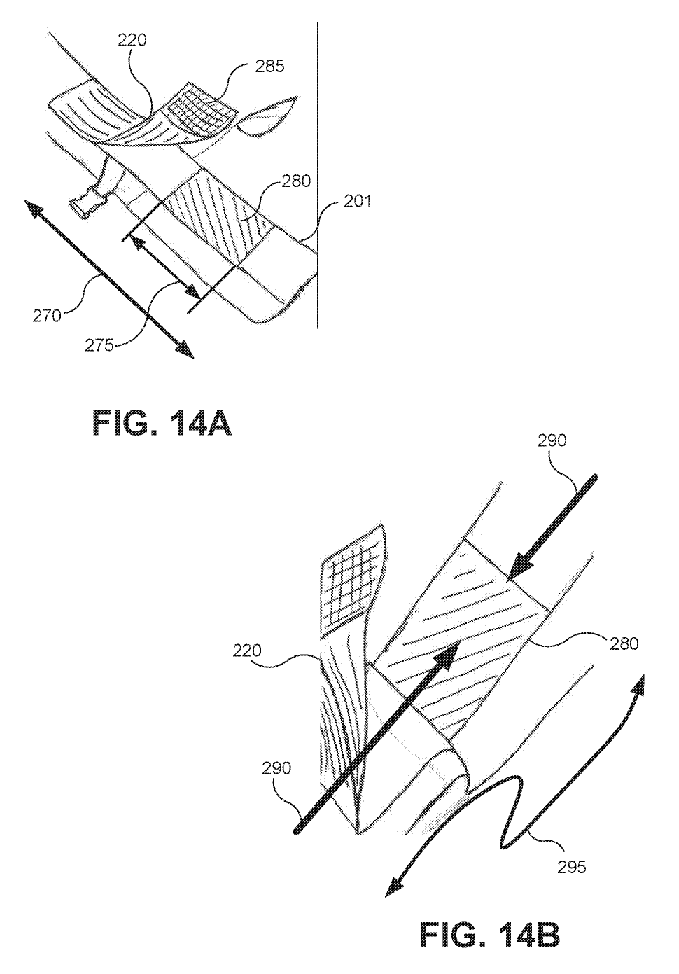

FIGS. 14A and 14B are pictorial diagrams that depict the structure and operation of one alternative example embodiment of a constriction flap. In this alternative example embodiment, a waistband 201 starts in a non-constricted state 270 as shown in FIG. 14A. The constriction flap 220 includes a hook material 285 disposed on a surface at the second end of the construction flap 220 and on the internal surface opposing the external surface of the waistband 201. The waistband includes a portion of loop material along a particular length 275 of the waistband 201. This length establishes a range for constriction of the waistband 201 by application of the constriction flap 220 at varying points along the length of the waistband 201.

When the constriction flap 220 is pulled 290 in order to constrict the waistband 201 about a human user's waist. The constriction flap 220 is then attached to the waistband 201 in a shortened length state 295. In this state, the waistband 201 actually bunches up along its length in order to match the dimension of a user's waist. It should be apparent that the dimension of the waistband 201 is hence adjustable based on the length 275 of the attachment material 280 disposed on the external surface of said waistband 201.

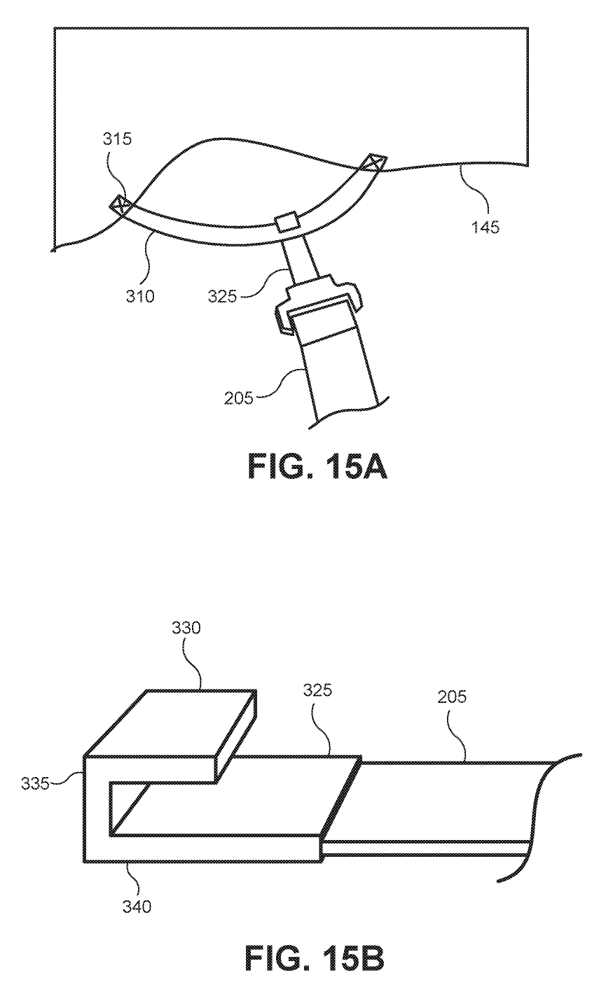

FIGS. 15A and 15B are pictorial diagrams that depict an alternative embodiment of a retainer useful for attaching a tension band to a handle. In many situations, a stratum 145 includes a handle 310 that is attached to the stratum. In many such stratums, the handle 310 includes two ends, each of which is attached to the stratum 145 at an attachment point 315. The attachment made at the attachment point 315 is typically accomplished by sewing the end of the handle 310 to the stratum 145.

In order to attach the tension band 205 to the handle 310, this alternative example embodiment includes a hook structure 325. In yet another alternative example embodiment, the hook structure 325 comprises a substantially rigid extension 340 to the tension band 205. A vertical offset member 335 is included at the end of the rigid extension 340. A return 330 is also included and projects back toward the tension band 205 from the end of the offset 335. The extension 340, the offset 335 and the return 330 define a hook structure that is used to pull on the handle 310 when the handle is encompassed in the hook structure.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for sliding a bed-bound person comprising:
attaching a horizontal force member to a stratum upon which a person is substantially positioned;
applying a horizontal force to the horizontal force member;
applying a substantially opposite horizontal force to a surface upon a human body substantially proximate to a lower back region; and
increasing the magnitude of the horizontal force and the substantially opposite horizontal force so as to cause the stratum to slide.

2. The method of claim 1 wherein attaching a horizontal force member to a stratum comprises at least one of attaching a horizontal force member to a bed-sheet, attaching a horizontal force member to a bed-pad, attaching a horizontal force member to a slide-sheet and attaching a horizontal force member to a slide-board.

3. The method of claim 1 wherein attaching a horizontal force member to a stratum comprises:
receiving a portion of a stratum into a friction loop; and
constricting the friction loop about the received portion of the stratum.

4. The method of claim 1 wherein attaching a horizontal force member to a stratum comprises:
providing a rigid extension at the end of the horizontal force member;
providing a vertical offset at the end of the rigid extension;
providing a rigid return at the end of the vertical offset; and
receiving a loop handle into a void defined by the rigid extension, the vertical offset and the rigid return.

5. The method of claim 1 wherein attaching a horizontal force member to a stratum comprises:
attaching a first horizontal force member to a first region included on the stratum; and
attaching a second horizontal force member to a second region included on the stratum wherein applying a horizontal force to the horizontal force member comprises:
applying a first horizontal force to the first horizontal force member; and
applying a second horizontal force to the second horizontal force member.

6. The method of claim 1 wherein attaching a horizontal force member to a stratum comprises at least one of attaching a horizontal force member to a stratum at a single region of said stratum and attaching a horizontal force member to a stratum at two regions of said stratum.

7. The method of claim 1 wherein applying a substantially opposite horizontal force to a surface upon a human body comprises:
applying a first force at a first rear flank of a lower torso region of a human body; and
applying a second force at a second and substantially opposite rear flank of the lower torso region of the human body.

8. The method of claim 1 wherein applying a substantially opposite horizontal force to a surface upon a human body comprises distributing a continuum of forces to a lower back portion of a human body beginning substantially at a right flank region and ending substantially at a left flank region wherein the continuum of forces are of greater magnitude at each of said flanks and decline in magnitude toward a center region of the lower back.

9. A torsional stress reducing harness comprising:
waistband comprising a flexible material for conforming to a human torso, said waist band further including a closure device;
constriction flap disposed on an outside surface of the waistband at a first end and including an attachment device for securing the second end of the constriction flap to the outer surface of the waist band at varying positions;
tension band including two ends wherein the first end is secured to the waist band; and
retainer included in the second end of the tension band.

10. The torsional stress reducer of claim 9 wherein the first end of the constriction flap is secured to the waist band proximate to a first flank portion of said waistband further comprising a second constriction flap that includes a first end and said first end is attached to the waist band proximate to a second flank portion.

11. The torsional stress reducing harness of claim 9 wherein the attachment device for securing the second end of the constriction flap to the outer surface of the waist band comprises:
at least one of a hook panel and a loop panel affixed to an inner surface of the constriction flap; and
corresponding hoop and loop material attached to the outer surface of the waist band.

12. The torsional stress reducing harness of claim 9 wherein the tension band includes a length adjustment device.

13. The torsional stress reducing harness of claim 9 wherein the retainer comprises a slide loop.

14. The torsional stress reducing harness of claim 9 wherein the retainer comprises a hook.

15. An apparatus for sliding a bed-bound person by reducing torsional stress on a rotator cuff comprising:
means for attaching a horizontal force member to a stratum upon which a person is substantially positioned;
means for applying a horizontal force to the horizontal force member;
means for applying a substantially opposite horizontal force to a surface upon a human body substantially proximate to a lower back region; and
means for increasing the magnitude of the horizontal force and the substantially opposite horizontal force so as to cause the stratum to slide.

16. The apparatus of claim 16 wherein the means for attaching a horizontal force member to a stratum comprises at least one of a means for attaching a horizontal force member to a bed-sheet, means for attaching a horizontal force member to a bed-pad, means for attaching a horizontal force member to a slide-sheet and means for attaching a horizontal force member to a slide-board.
